(19) United States
(12) Patent Application Publication
(10) Pub. No.: US 2025/0013011 A1
(43) Pub. Date: Jan. 9, 2025

(54) OPTICAL IMAGING SYSTEM

(71) Applicant: Samsung Electro-Mechanics Co., Ltd., Suwon-si (KR)

(72) Inventors: Kum Ho KIM, Suwon-si (KR); Su Hyeok LEE, Suwon-si (KR); Yong Joo JO, Suwon-si (KR); Tae Yeon LIM, Suwon-si (KR)

(73) Assignee: Samsung Electro-Mechanics Co., Ltd., Suwon-si (KR)

(21) Appl. No.: 18/613,391

(22) Filed: Mar. 22, 2024

(30) Foreign Application Priority Data
Jul. 4, 2023 (KR) 10-2023-0086727

(51) Int. Cl. G02B 13/00; G02B 9/64

(52) U.S. Cl. CPC G02B 13/0045; G02B 9/64

(57) ABSTRACT

An optical imaging system includes a first lens having a negative refractive power, a second lens, a third lens having a convex image-side surface, a fourth lens, a fifth lens having a negative refractive power, a sixth lens having a positive refractive power, and a seventh lens having a convex object-side surface. The first to seventh lenses are sequentially disposed from an object side, and TTL/IMH<1.2 is satisfied, where TTL is a distance on an optical axis from an object-side surface of the first lens to an image plane, and IMH is a height of the image plane.

### CROSS-REFERENCE TO RELATED APPLICATION

This application claims the benefit under 35 USC 119(a) of Korean Patent Application No. 10-2023-0086727 filed on Jul. 4, 2023, in the Korean Intellectual Property Office, the entire disclosure of which is incorporated herein by reference for all purposes.

### BACKGROUND

### 1. Field

The present disclosure relates to an optical imaging system.

### 2. Description of the Background

A portable terminal may include a wide-angle camera with a short focal length and a telephoto camera with a long focal length to provide images of various magnifications.

Large image sensors may be developed for high pixel counts, and an optical system with a low Fno value may be desired to obtain a bright image even when shooting in low light conditions.

The above information is presented as background information only to assist with an understanding of the present disclosure. No determination has been made, and no assertion is made, as to whether any of the above might be applicable as prior art with regard to the disclosure.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In one general aspect, an optical imaging system includes a first lens having a negative refractive power, a second lens, a third lens having a convex image-side surface, a fourth lens, a fifth lens having a negative refractive power, a sixth lens having a positive refractive power, and a seventh lens having a convex object-side surface. The first to seventh lenses are sequentially disposed from an object side, and TTL/IMH<1.2 is satisfied, where TTL is a distance on an optical axis from an object-side surface of the first lens to an image plane, and IMH is a height of the image plane.

The second lens may have a positive refractive power, and an image-side surface of the second surface may be concave.

An object-side surface of the sixth lens may be concave.

50<FOV/f may be satisfied, where FOV is a field of view of the optical imaging system, and f is a focal length of the optical imaging system.

f/EPD<1.8 may be satisfied, where f is a focal length of the optical imaging system, and EPD is a diameter of an entrance pupil.

L6R1/CT6<−3 may be satisfied, where L6R1 is a radius of curvature of the object-side surface of the sixth lens, and CT6 is a central thickness of the sixth lens.

15<v1−v2<40 and 0<v1−v5<45 may be satisfied, where v1 is an Abbe number of the first lens, v2 is an Abbe number of the second lens, and v5 is an Abbe number of the fifth lens.

1.6<ET1/CT1 may be satisfied, where ET1 is an edge thickness of the first lens, and CT1 is a central thickness of the first lens.

An object-side surface of the first lens may be concave, and the fourth lens may have positive refractive power.

An image-side surface of the fifth lens may be concave, and the seventh lens may have negative refractive power.

In another general aspect, an optical imaging system includes a first lens of which both an object-side surface and an image-side surface are concave, a second lens, a third lens having a positive refractive power, a fourth lens having a positive refractive power, a fifth lens, a sixth lens having a concave object-side surface, and a seventh lens having a convex object-side surface. The first to seventh lenses may be sequentially disposed from an object side. Any one or any combination of any two or more surfaces of the first lens and the seventh lens may include one or more inflection points, and f/EPD<1.8 may be satisfied, where f is a focal length of the optical imaging system, and EPD is a diameter of an entrance pupil.

SD6/SD14<0.5 may be satisfied, where SD6 is an effective diameter of the image-side surface of the third lens, and SD14 is an effective diameter of the image-side surface of the seventh lens.

The first lens may have a negative refractive power, and −4<f1/f<0 may be satisfied, where f1 is a focal distance of the first lens, and f is a focal length of the optical imaging system.

An image-side surface of the fifth lens may be convex, and the seventh lens may have a positive refractive power.

An image-side surface of the fifth lens may be concave, and the seventh lens may have a negative refractive power.

TTL/IMH<1.2 may be satisfied, where TTL is a distance on an optical axis from the object-side surface of the first lens to an image plane, and IMH is a height of the image plane.

Other features and aspects will be apparent from the following detailed description, the drawings, and the claims.

### BRIEF DESCRIPTION OF DRAWINGS

FIG. 1 is a configuration diagram of an optical imaging system according to a first embodiment of the present disclosure.

FIG. 2 is a graph illustrating the aberration characteristics of the optical imaging system illustrated in FIG. 1.

FIG. 3 is a configuration diagram of an optical imaging system according to a second embodiment of the present disclosure.

FIG. 4 is a graph illustrating aberration characteristics of the optical imaging system illustrated in FIG. 3.

FIG. 5 is an optical imaging system configuration diagram according to a third embodiment of the present disclosure.

FIG. 6 is a graph illustrating the aberration characteristics of the optical imaging system illustrated in FIG. 5.

FIG. 7 is a configuration diagram of an optical imaging system according to a fourth embodiment of the present disclosure.

FIG. 8 is a graph illustrating the aberration characteristics of the optical imaging system illustrated in FIG. 7.

FIG. 9 is an optical imaging system configuration diagram according to a fifth embodiment of the present disclosure.

FIG. 10 is a graph illustrating the aberration characteristics of the optical imaging system illustrated in FIG. 9.

FIG. 11 is a configuration diagram of an optical imaging system according to a sixth embodiment of the present disclosure.

FIG. 12 is a graph illustrating the aberration characteristics of the optical imaging system illustrated in FIG. 11.

FIG. 13 is an optical imaging system configuration diagram according to a seventh embodiment of the present disclosure.

FIG. 14 is a graph illustrating the aberration characteristics of the optical imaging system illustrated in FIG. 13.

FIG. 15 is an optical imaging system configuration diagram according to an eighth embodiment of the present disclosure.

FIG. 16 is a graph illustrating the aberration characteristics of the optical imaging system illustrated in FIG. 15.

Throughout the drawings and the detailed description, unless otherwise described, the same reference numerals refer to the same elements. The drawings may not be to scale, and the relative size, proportions, and depiction of elements in the drawings may be exaggerated for clarity, illustration, and convenience.

### DETAILED DESCRIPTION

Hereinafter, while examples of the present disclosure will be described in detail with reference to the accompanying drawings, it is noted that examples are not limited to the same.

The following detailed description is provided to assist the reader in gaining a comprehensive understanding of the methods, apparatuses, and/or systems described herein. However, various changes, modifications, and equivalents of the methods, apparatuses, and/or systems described herein will be apparent after an understanding of this disclosure. For example, the sequences of operations described herein are merely examples, and are not limited to those set forth herein, but may be changed as will be apparent after an understanding of this disclosure, with the exception of operations necessarily occurring in a certain order. Also, descriptions of features that are known in the art may be omitted for increased clarity and conciseness.

The features described herein may be embodied in different forms, and are not to be construed as being limited to the examples described herein. Rather, the examples described herein have been provided merely to illustrate some of the many possible ways of implementing the methods, apparatuses, and/or systems described herein that will be apparent after an understanding of this disclosure.

Throughout the specification, when an element, such as a layer, region, or substrate is described as being “on,” “connected to,” or “coupled to” another element, it may be directly “on,” “connected to,” or “coupled to” the other element, or there may be one or more other elements intervening therebetween. In contrast, when an element is described as being “directly on,” “directly connected to,” or “directly coupled to” another element, there can be no other elements intervening therebetween.

As used herein, the term “and/or” includes any one and any combination of any two or more of the associated listed items; likewise, “at least one of” includes any one and any combination of any two or more of the associated listed items.

Although terms such as “first,” “second,” and “third” may be used herein to describe various members, components, regions, layers, or sections, these members, components, regions, layers, or sections are not to be limited by these terms. Rather, these terms are only used to distinguish one member, component, region, layer, or section from another member, component, region, layer, or section. Thus, a first member, component, region, layer, or section referred to in examples described herein may also be referred to as a second member, component, region, layer, or section without departing from the teachings of the examples.

Spatially relative terms, such as “above,” “upper,” “below,” “lower,” and the like, may be used herein for ease of description to describe one element's relationship to another element as shown in the figures. Such spatially relative terms are intended to encompass different orientations of the device in use or operation in addition to the orientation depicted in the figures. For example, if the device in the figures is turned over, an element described as being “above,” or “upper” relative to another element would then be “below,” or “lower” relative to the other element. Thus, the term “above” encompasses both the above and below orientations depending on the spatial orientation of the device. The device may also be oriented in other ways (rotated 90 degrees or at other orientations), and the spatially relative terms used herein are to be interpreted accordingly.

The terminology used herein is for describing various examples only, and is not to be used to limit the disclosure. The articles “a,” “an,” and “the” are intended to include the plural forms as well, unless the context clearly indicates otherwise. The terms “comprises,” “includes,” and “has” specify the presence of stated features, numbers, operations, members, elements, and/or combinations thereof, but do not preclude the presence or addition of one or more other features, numbers, operations, members, elements, and/or combinations thereof.

Due to manufacturing techniques and/or tolerances, variations of the shapes shown in the drawings may occur. Thus, the examples described herein are not limited to the specific shapes shown in the drawings, but include changes in shape that occur during manufacturing.

Herein, it is noted that use of the term “may” with respect to an example, for example, as to what an example may include or implement, means that at least one example exists in which such a feature is included or implemented while all examples are not limited thereto.

The features of the examples described herein may be combined in various ways as will be apparent after an understanding of this disclosure. Further, although the examples described herein have a variety of configurations, other configurations are possible as will be apparent after an understanding of this disclosure.

In the present specification, in the description of a lens shape, the configuration in which one surface is convex indicates that a paraxial region of the surface is convex, and one surface is concave, indicating that a paraxial region of the surface is concave. Thus, even when it is described that one surface of a lens is convex, an edge of the lens may be concave. Similarly, even when it is described that one surface of a lens is concave, an edge of the lens may be convex.

According to the present disclosure, an optical imaging system may include seven lenses disposed along an optical axis. For example, the optical imaging system may include a first lens, a second lens, a third lens, a fourth lens, a fifth lens, a sixth lens, and a seventh lens, which may be sequentially disposed from an object side along the optical axis. According to the present disclosure, in the optical imaging system, the first lens refers to a lens most adjacent to an object (or a subject), and the seventh lens refers to a lens most adjacent to an image sensor.

According to the present disclosure, the optical imaging system may include an image sensor for converting light passing through the lenses into an electrical signal and an infrared (IR) cut filter for blocking light in an infrared region of the light passing through the lenses. The image sensor may include an image plane on which an image of a subject is formed, and the infrared cut filter may be disposed between a lens most adjacent to the image sensor and an image sensor.

According to the present disclosure, the optical imaging system may include a stop for adjusting an amount of light. For example, the optical imaging system may include a stop between the second lens and the third lens.

According to the present disclosure, the optical imaging system may include a lens formed of a plastic material. For example, at least one of the first to seventh lenses may be a lens formed of a plastic material, and preferably, all of the first to seventh lenses may be lenses formed of a plastic material. Furthermore, at least some of the first to seventh lenses may be formed of different plastic materials with different refractive indices and/or Abbe numbers.

According to the present disclosure, the optical imaging system may include an aspherical lens. For example, at least one of the first to seventh lenses may have an aspherical surface, at least one of an object-side surface, and an image-side surface thereof. The aspherical surface of the first to seventh lenses may be expressed by Equation 1 below.

$$Z = \frac{{cY}^{2}}{1 + \sqrt{1 - ( 1 + K ) {c}^{2} {Y}^{2}}} + {AY}^{4} + {BY}^{6} + {CY}^{8} + {DY}^{10} + {EY}^{12} + {FY}^{14} + {GY}^{16} + {HY}^{18} + {JY}^{20} + {LY}^{22} + {MY}^{24} + {NY}^{26} + {OY}^{28} + {PY}^{30} \qquad [ Equation 1 ]$$

In Equation 1, c is a reciprocal of a radius of curvature of the lens, k is a conical constant, Y is a distance from any point on an aspherical surface to an optical axis, A to H, J, and L to P are aspherical surface constants from the 4^{th} to the 30^{th} order in order, and Z (or SAG) is a distance from any point on the aspherical surface to an apex of the corresponding aspherical surface in an optical axis direction.

In addition, according to the present disclosure, the optical imaging system may satisfy at least one of the following Conditional Expressions.

−4<f1/f<0 [Conditional Expression 1]

f/EPD<1.8 [Conditional Expression 2]

15<v1−v2<40 [Conditional Expression 3]

25<v1−v5<45 [Conditional Expression 4]

0<v1−v7<40 [Conditional Expression 5]

TTL/IMH<1.2 [Conditional Expression 6]

50<FOV/f(unit: °·mm⁻¹) [Conditional Expression 7]

L6R1/CT6<−3 [Conditional Expression 8]

1.6<ET1/CT1 [Conditional Expression 9]

2.5<SD1/SD5<4 [Conditional Expression 10]

SD6/SD14<0.5 [Conditional Expression 11]

In [Conditional Expression 1], f1 is a focal length of the first lens, and f is a focal length of the optical imaging system. A wide field of view (a field of view suitable for an ultra-wide-angle lens) may be secured only when the range according to [Conditional Expression 1] is satisfied.

In [Conditional Expression 2], f is a focal length of the optical imaging system, and EPD is a diameter of an entrance pupil. [Conditional Expression 2] illustrates a condition (f value) defining the brightness of the optical imaging system, and the desired bright optical system may be implemented only when the range according to [Conditional Expression 2] is satisfied.

In [Conditional Expression 3] to [Conditional Expression 5], v1 is an Abbe number of the first lens, v2 is an Abbe number of the second lens, v5 is an Abbe number of the fifth lens, and v7 is an Abbe number of the seventh lens. Chromatic aberration may be minimized only when the range according to [Conditional Expression 3] to [Conditional Expression 5] is satisfied.

In [Conditional Expression 6], TTL is a distance on an optical axis from an object-side surface of the first lens to an image plane, and IMH is a height of the image plane (half of a diagonal length). Miniaturization may be achieved only when the range according to [Conditional Expression 6] is satisfied.

In [Conditional Expression 7], FOV is a field of view of the optical imaging system, and f is a focal length of the optical imaging system. The purpose of a wide-angle lens may be achieved only when the range according to [Conditional Expression 7] is satisfied.

In [Conditional Expression 8], L6R1 is a radius of curvature of the object-side surface of the sixth lens, and CT6 is a central thickness of the sixth lens. When it exceeds the range according to [Conditional Expression 8], it becomes difficult to correct a light blurring phenomenon.

In [Conditional Expression 9], ET1 is an edge thickness of the first lens, and CT1 is a central thickness of the first lens. When this is beyond the range according to [Conditional Expression 9], securing an ambient light ratio and correct aberration becomes difficult.

In [Conditional Expression 10], SD1 is an effective diameter of the object-side surface of the first lens, and SD5 is an effective diameter of the object-side surface of the third lens. When this is beyond the range according to [Conditional Expression 10], it becomes difficult to implement a wide field of view.

In [Conditional Expression 11], SD6 is an effective diameter of the image-side of the third lens, and SD14 is an effective diameter of the image-side of the seventh lens. When this is beyond the range according to [Conditional Expression 11], it becomes difficult to achieve high-resolution.

Hereinafter, various embodiments of an optical imaging system will be described according to the present disclosure.

### First Embodiment

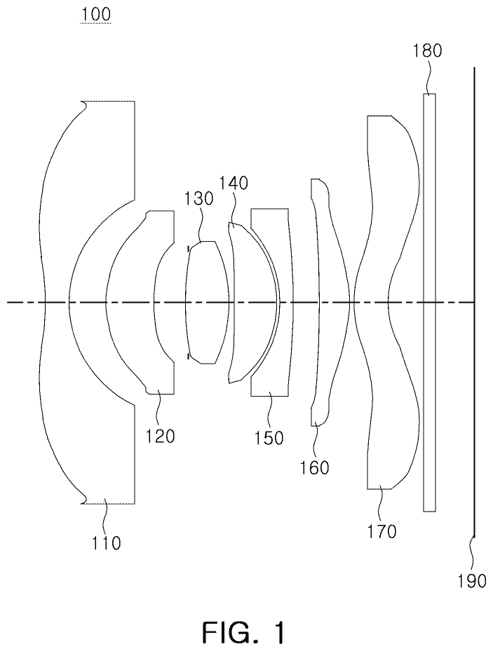

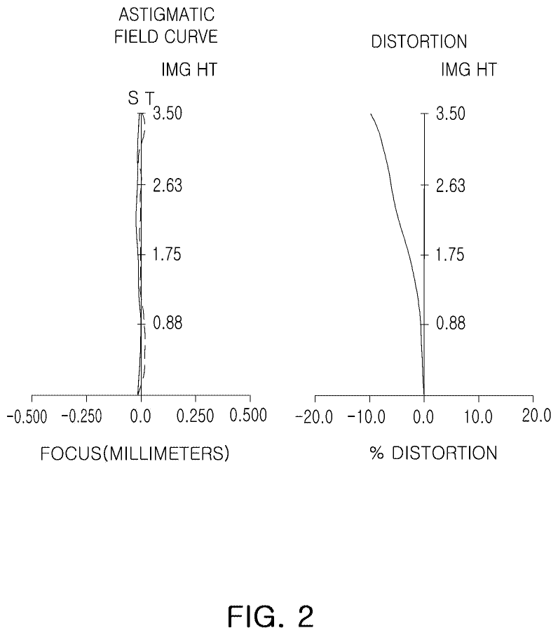

FIG. 1 is a configuration diagram of an optical imaging system according to a first embodiment of the present disclosure, and FIG. 2 is a graph illustrating aberration characteristics of the optical imaging system illustrated in FIG. 1.

An optical imaging system 100, according to a first embodiment of the present disclosure, may include a first lens 110, a second lens 120, a third lens 130, a fourth lens 140, a fifth lens 150, a sixth lens 160, and a seventh lens 170.

The first lens 110 may have negative refractive power, and both an object-side surface and an image-side surface of the first lens 110 may be concave. In addition, the object-side surface of the first lens 110 may include at least one inflection point. That is, the object-side surface of the first lens 110 may be concave in a paraxial portion, but may be convex in an edge portion. The second lens 120 may have positive refractive power, an object-side surface of the second lens 120 may be convex, and an image-side surface of the second lens 120 may be concave. The third lens 130 may have positive refractive power, and both an object-side surface and an image-side surface of the third lens 130 may be convex. The fourth lens 140 may have positive refractive power, and both an object-side surface and an image-side surface of the fourth lens 140 may be convex. The fifth lens 150 may have negative refractive power, an object-side surface of the fifth lens 150 may be concave, and an image-side surface of the fifth lens 150 may be convex. The sixth lens 160 may have positive refractive power, an object-side surface of the sixth lens 160 may be concave, and an image-side surface of the sixth lens 160 may be convex. The seventh lens 170 may have positive refractive power, an object-side surface of the seventh lens 170 may be convex, and an image-side surface of the seventh lens 170 may be concave. In addition, each of the object-side surface and the image-side surface of the seventh lens 170 may include at least one inflection point. That is, the object-side surface of the seventh lens 170 may be convex in a paraxial portion, but may be concave in an edge portion, and the image-side surface of the seventh lens 170 may be concave in the paraxial portion, but may be convex in the edge portion.

The optical imaging system 100 according to the first embodiment of the present disclosure may include an infrared cut filter 180 and an image sensor 190 after the seventh lens 170, and may further include a STOP between the second lens 120 and the third lens 130.

Table 1 illustrates the characteristics of the optical imaging system 100 according to the first embodiment of the present disclosure. A focal length of the optical imaging system 100, according to the first embodiment of the present disclosure, is 2.0 mm, a field of view is 125.0 degrees, a height of an image plane is 7.0 mm, and a F value is 1.7.

TABLE 1

| Surface No. | | | | | |
|---|---|---|---|---|---|
| (*aspherical | | Radius of | Thickness, | Refractive | Abbe |
| surface) | Component | curvature | distance | index | number |
| 0 | Object | Infinity | Infinity | | |
| 1 | | Infinity | 0.857 | | |
| 2* | First lens | −1.58 | 0.400 | 1.537 | 55.7 |
| 3* | | 78.19 | 0.633 | | |
| 4* | Second lens | 1.87 | 0.819 | 1.619 | 25.9 |
| 5* | | 2.80 | 0.612 | | |
| | (STOP) | Infinity | −0.052 | | |
| 6* | Third lens | 4.74 | 0.748 | 1.546 | 56.0 |
| 7* | | −5.45 | 0.081 | | |
| 8* | Fourth lens | 6.20 | 0.735 | 1.546 | 56.0 |
| 9* | | −1.99 | 0.063 | | |
| 10* | Fifth lens | −2.47 | 0.230 | 1.677 | 19.2 |
| 11* | | −62.54 | 0.440 | | |
| 12* | Sixth lens | −3.89 | 0.537 | 1.546 | 56.0 |
| 13* | | −1.85 | 0.050 | | |
| 14* | Seventh lens | 1.21 | 0.593 | 1.537 | 55.7 |
| 15* | | 1.01 | 0.607 | | |
| 16 | IR cut Filter | Infinity | 0.210 | 1.518 | 64.2 |
| 17 | | Infinity | 0.675 | | |
| 18 | Image | Infinity | 0.015 | | |

Table 2 illustrates an aspherical value of the optical imaging system 100 according to the first embodiment of the present disclosure.

TABLE 2

| Surface No | 2 | 3 | 4 | 5 | 6 | 7 | 8 |
|---|---|---|---|---|---|---|---|
| K | −13.459 | 29.705 | −2.110 | −0.138 | −1.901 | 15.350 | 20.415 |
| A | 0.142 | 0.502 | 0.050 | 0.095 | −0.015 | −0.232 | −0.249 |
| B | −0.130 | −0.867 | 0.119 | −0.311 | 0.525 | 0.036 | 0.404 |
| C | 0.089 | 1.816 | −1.235 | 3.933 | −7.702 | 3.222 | −1.982 |
| D | −0.045 | −3.631 | 5.864 | −28.564 | 72.984 | −27.580 | 10.710 |
| E | 0.017 | 5.779 | −17.264 | 140.756 | −471.669 | 140.573 | −42.637 |
| F | −0.005 | −6.872 | 34.401 | −482.181 | 2150.978 | −486.715 | 120.273 |
| G | 0.001 | 6.024 | −48.174 | 1171.957 | −7060.829 | 1192.878 | −242.284 |
| H | 0.000 | −3.879 | 48.269 | −2036.958 | 16827.165 | −2105.972 | 351.164 |
| J | 0.000 | 1.825 | −34.753 | 2521.444 | −29069.76 | 2687.884 | −366.169 |
| L | 0.000 | −0.618 | 17.822 | −2182.390 | 35949.458 | −2457.254 | 271.699 |
| M | 0.000 | 0.147 | −6.347 | 1270.217 | −30956.21 | 1568.555 | −139.702 |
| N | 0.000 | −0.023 | 1.491 | −460.851 | 17599.302 | −663.813 | 47.220 |
| O | 0.000 | 0.002 | −0.207 | 88.849 | −5930.266 | 167.328 | −9.418 |
| P | 0.000 | 0.000 | 0.013 | −5.841 | 896.035 | −19.013 | 0.838 |

| | 9 | 10 | 11 | 12 | 13 | 14 | 15 |
|---|---|---|---|---|---|---|---|
| K | −1.268 | 1.490 | 99.000 | −25.651 | −1.871 | −1.449 | −0.923 |
| A | 0.540 | 0.692 | 0.290 | 0.366 | 0.040 | −0.318 | −0.387 |
| B | −4.073 | −4.988 | −1.925 | −0.871 | 0.206 | 0.373 | 0.360 |
| C | 17.408 | 19.639 | 6.137 | 1.564 | −0.587 | −0.385 | −0.309 |
| D | −55.762 | −56.107 | −13.564 | −2.171 | 1.065 | 0.301 | 0.203 |
| E | 136.168 | 122.262 | 22.385 | 2.142 | −1.450 | −0.176 | −0.099 |
| F | −251.705 | −201.700 | −27.927 | −1.380 | 1.454 | 0.077 | 0.036 |
| G | 350.235 | 247.989 | 26.242 | 0.458 | −1.057 | −0.026 | −0.010 |
| H | −365.663 | −224.088 | −18.427 | 0.064 | 0.554 | 0.007 | 0.002 |
| J | 284.802 | 146.372 | 9.555 | −0.156 | −0.208 | −0.001 | 0.000 |
| L | −163.244 | −67.277 | −3.589 | 0.085 | 0.055 | 0.000 | 0.000 |
| M | 66.977 | 20.731 | 0.945 | −0.026 | −0.010 | 0.000 | 0.000 |
| N | −18.649 | −3.897 | −0.165 | 0.005 | 0.001 | 0.000 | 0.000 |
| O | 3.162 | 0.359 | 0.017 | −0.001 | 0.000 | 0.000 | 0.000 |
| P | −0.247 | −0.007 | −0.001 | 0.000 | 0.000 | 0.000 | 0.000 |

### Second Embodiment

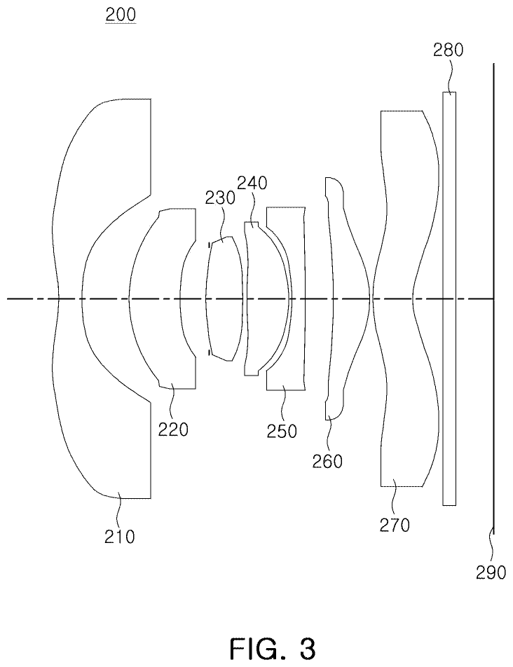

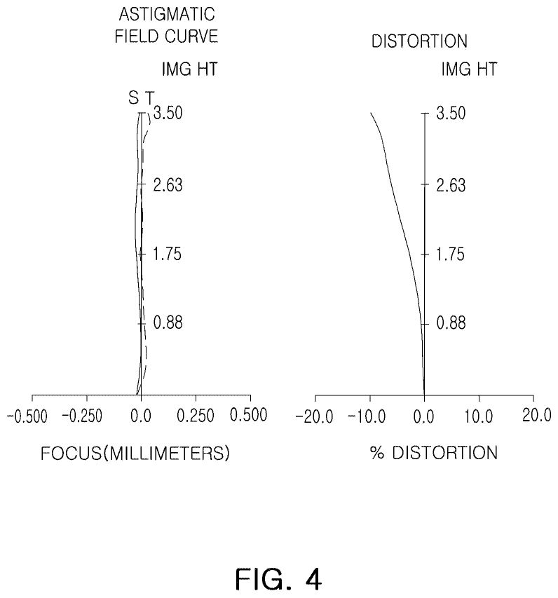

FIG. 3 is a configuration diagram of an optical imaging system according to a second embodiment of the present disclosure, and FIG. 4 is a graph illustrating the aberration characteristics of the optical imaging system illustrated in FIG. 3.

An optical imaging system 200, according to a second embodiment of the present disclosure, may include a first lens 210, a second lens 220, a third lens 230, a fourth lens 240, a fifth lens 250, a sixth lens 260, and a seventh lens 270.

The first lens 210 may have negative refractive power, and both an object-side surface and an image-side surface of the first lens 210 may be concave. In addition, the object-side surface of the first lens 210 may include at least one inflection point. That is, the object-side surface of the first lens 210 may be concave in a paraxial portion, but may be convex in an edge portion. The second lens 220 may have positive refractive power, an object-side surface of the second lens 220 may be convex, and an image-side surface of the second lens 220 may be concave. The third lens 230 may have positive refractive power, and both an object-side surface and an image-side surface of the third lens 230 may be convex. The fourth lens 240 may have positive refractive power, and both an object-side surface and an image-side surface of the fourth lens 240 may be convex. The fifth lens 250 may have negative refractive power, and both an object-side surface and an image-side surface of the fifth lens 250 may be concave. In addition, the image-side surface of the fifth lens 250 may include at least one inflection point. That is, the image-side surface of the fifth lens 250 may be concave in a paraxial portion, but may be convex in an edge portion. The sixth lens 260 may have positive refractive power, an object-side surface of the sixth lens 260 may be concave, and an image-side surface of the sixth lens 260 may be convex. The seventh lens 270 may have negative refractive power, an object-side surface of the seventh lens 270 may be convex, and an image-side surface of the seventh lens 270 may be concave. In addition, each of the object-side surface and the image-side surface of the seventh lens 270 may include at least one inflection point. That is, the object-side surface of the seventh lens 270 may be convex in a paraxial portion, but may be concave in an edge portion, and the image-side surface of the seventh lens 270 may be concave in the paraxial portion, but may be convex in the edge portion.

The optical imaging system 200, according to the second embodiment of the present disclosure, may include an infrared cut filter 280 and an image sensor 290 after the seventh lens 270, and may further include a STOP between the second lens 220 and the third lens 230.

Table 3 illustrates the characteristics of the optical imaging system 200 according to the second embodiment of the present disclosure. A focal length of the optical imaging system 200, according to the second embodiment of the present disclosure, is 2.0 mm, a field of view is 125.0 degrees, a height of an image plane is 7.0 mm, and a F value is 1.7.

TABLE 3

| Surface No. | | | | Refrac- | |
|---|---|---|---|---|---|
| (*aspherical | | Radius of | Thickness, | tive | Abbe |
| surface) | Component | curvature | distance | index | number |
| 0 | Object | Infinity | Infinity | | |
| 1 | | Infinity | 0.857 | | |
| 2* | First lens | −1.88187 | 0.400 | 1.537 | 55.7 |
| 3* | | 8.51 | 0.798 | | |
| 4* | Second lens | 1.97 | 0.900 | 1.619 | 25.9 |
| 5* | | 3.38 | 0.505 | | |
| | (STOP) | Infinity | −0.068 | | |
| 6* | Third lens | 4.638795 | 0.664 | 1.546 | 56.0 |
| 7* | | −11.66 | 0.059 | | |
| 8* | Fourth lens | 5.23 | 0.716 | 1.546 | 56.0 |
| 9* | | −1.72 | 0.050 | | |
| 10* | Fifth lens | −3.58 | 0.230 | 1.677 | 19.2 |
| 11* | | 7.23 | 0.490 | | |
| 12* | Sixth lens | −3.81 | 0.634 | 1.546 | 56.0 |
| 13* | | −1.45 | 0.050 | | |
| 14* | Seventh lens | 1.84 | 0.687 | 1.570 | 37.4 |
| 15* | | 1.19 | 0.521 | | |
| 16 | IR cut Filter | Infinity | 0.210 | 1.518 | 64.2 |
| 17 | | Infinity | 0.667 | | |
| 18 | Image | Infinity | 0.022 | | |

Table 4 illustrates an aspherical value of the optical imaging system 200 according to the second embodiment of the present disclosure.

TABLE 4

| Surface No. | 2 | 3 | 4 | 5 | 6 | 7 | 8 |
|---|---|---|---|---|---|---|---|
| K | −17.263 | 19.748 | −3.449 | −4.450 | 1.786 | 47.435 | 15.695 |
| A | 0.128 | 0.425 | 0.045 | 0.104 | −0.012 | −0.244 | −0.241 |
| B | −0.111 | −0.751 | 0.164 | −0.560 | 0.603 | 0.173 | 0.374 |
| C | 0.072 | 1.769 | −1.380 | 6.270 | −9.019 | 0.180 | −2.029 |
| D | −0.035 | −3.972 | 6.007 | −41.433 | 85.553 | −0.276 | 9.754 |
| E | 0.013 | 6.924 | −16.987 | 179.501 | −543.449 | −8.292 | −29.622 |
| F | −0.004 | −8.899 | 33.318 | −525.810 | 2409.202 | 62.235 | 53.608 |
| G | 0.001 | 8.393 | −46.712 | 1050.294 | −7637.310 | −229.723 | −41.299 |
| H | 0.000 | −5.812 | 47.448 | −1397.082 | 17513.589 | 524.997 | −50.167 |
| J | 0.000 | 2.942 | −34.963 | 1125.370 | −29066.25 | −792.242 | 187.465 |
| L | 0.000 | −1.074 | 18.485 | −335.671 | 34520.577 | 802.307 | −260.363 |
| M | 0.000 | 0.274 | −6.827 | −302.345 | −28558.81 | −537.793 | 210.646 |
| N | 0.000 | −0.046 | 1.671 | 384.824 | 15610.341 | 227.532 | −103.562 |
| O | 0.000 | 0.005 | −0.243 | −173.223 | −5061.498 | −54.528 | 28.783 |
| P | 0.000 | 0.000 | 0.016 | 29.872 | 736.492 | 5.562 | −3.479 |

| | 9 | 10 | 11 | 12 | 13 | 14 | 15 |
|---|---|---|---|---|---|---|---|
| K | −2.257 | 4.117 | −85.916 | −6.605 | −1.624 | −2.465 | −0.918 |
| A | 0.835 | 0.833 | 0.218 | 0.212 | 0.088 | −0.127 | −0.310 |
| B | −5.595 | −5.642 | −1.460 | −0.310 | −0.022 | 0.041 | 0.269 |
| C | 23.630 | 21.180 | 4.163 | 0.144 | −0.128 | 0.050 | −0.215 |
| D | −78.068 | −58.969 | −7.947 | 0.586 | 0.386 | −0.111 | 0.134 |
| E | 206.323 | 127.690 | 10.856 | −1.894 | −0.587 | 0.108 | −0.062 |
| F | −432.574 | −215.598 | −10.343 | 3.069 | 0.546 | −0.066 | 0.022 |
| G | 707.802 | 282.468 | 6.092 | −3.231 | −0.313 | 0.028 | −0.006 |
| H | −888.614 | −286.073 | −1.060 | 2.358 | 0.101 | −0.008 | 0.001 |
| J | 840.104 | 222.332 | −1.623 | −1.219 | −0.008 | 0.002 | 0.000 |
| L | −583.806 | −130.321 | 1.696 | 0.446 | −0.007 | 0.000 | 0.000 |
| M | 287.769 | 55.691 | −0.836 | −0.113 | 0.003 | 0.000 | 0.000 |
| N | −94.869 | −16.327 | 0.240 | 0.019 | −0.001 | 0.000 | 0.000 |
| O | 18.703 | 2.925 | −0.039 | −0.002 | 0.000 | 0.000 | 0.000 |
| P | −1.663 | −0.241 | 0.003 | 0.000 | 0.000 | 0.000 | 0.000 |

### Third Embodiment

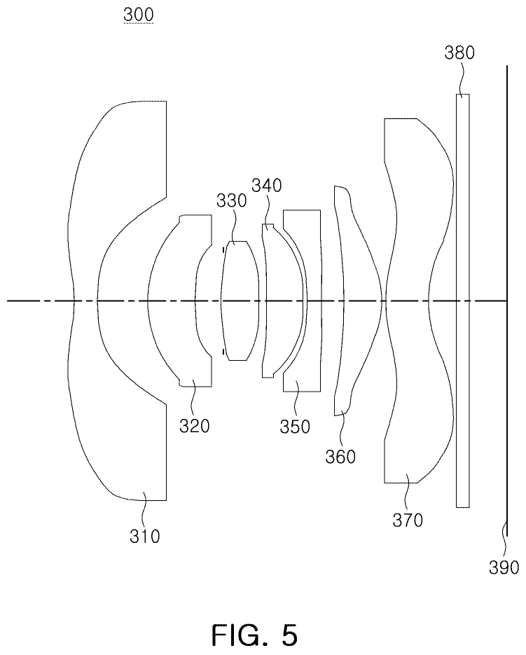

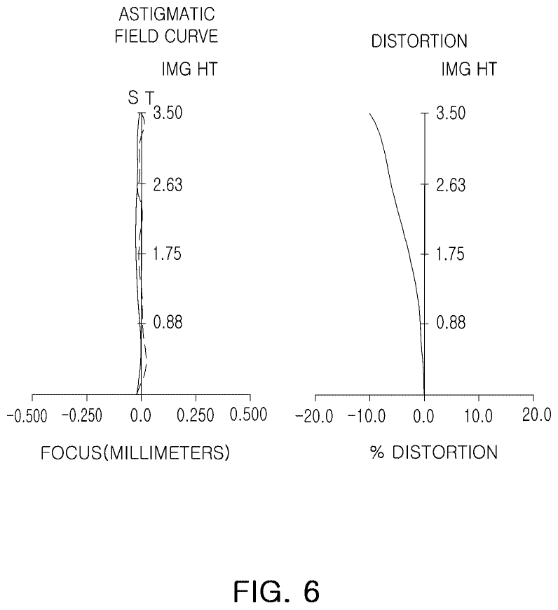

FIG. 5 is a configuration diagram of an optical imaging system according to a third embodiment of the present disclosure, and FIG. 6 is a graph illustrating the aberration characteristics of the optical imaging system illustrated in FIG. 5.

An optical imaging system 300, according to a third embodiment of the present disclosure, may include a first lens 310, a second lens 320, a third lens 330, a fourth lens 340, a fifth lens 350, a sixth lens 360, and a seventh lens 370.

The first lens 310 may have negative refractive power, and both an object-side surface and an image-side surface of the first lens 310 may be concave. In addition, the object-side surface of the first lens 310 may include at least one inflection point. That is, the object-side surface of the first lens 310 may be concave in a paraxial portion, but may be convex in an edge portion. The second lens 320 may have positive refractive power, an object-side surface of the second lens 320 may be convex, and an image-side surface of the second lens 320 may be concave. The third lens 330 may have positive refractive power, and both an object-side surface and an image-side surface of the third lens 330 may be convex. The fourth lens 340 may have positive refractive power, and both an object-side surface and an image-side surface of the fourth lens 340 may be convex. The fifth lens 350 may have negative refractive power, and both an object-side surface and an image-side surface of the fifth lens 350 may be concave. In addition, the image-side surface of the fifth lens 350 may include at least one inflection point. That is, the image-side surface of the fifth lens 350 may be concave in a paraxial portion, but may be convex in an edge portion. The sixth lens 360 may have positive refractive power, an object-side surface of the sixth lens 360 may be concave, and an image-side surface of the sixth lens 360 may be convex. The seventh lens 370 may have negative refractive power, an object-side surface of the seventh lens 370 may be convex, and an image-side surface of the seventh lens 370 may be concave. In addition, each of the object-side surface and the image-side surface of the seventh lens 370 may include at least one inflection point. That is, the object-side surface of the seventh lens 370 may be convex in a paraxial portion, but concave in an edge portion, and the image-side surface of the seventh lens 370 may be concave in the paraxial portion, but may be convex in the edge portion.

The optical imaging system 300, according to the third embodiment of the present disclosure, may include an infrared cut filter 380 and an image sensor 390 after the seventh lens 370, and may further include a STOP between the second lens 320 and the third lens 330.

Table 5 illustrates the characteristics of the optical imaging system 300 according to the third embodiment of the present disclosure. A focal length of the optical imaging system 300, according to the third embodiment of the present disclosure, is 2.0 mm, a field of view is 125.2 degrees, a height of an image plane is 7.0 mm, and a F value is 1.7.

TABLE 5

| Surface No. | | | | | |
|---|---|---|---|---|---|
| (*aspherical | | Radius of | Thickness, | Refractive | Abbe |
| surface) | Component | curvature | distance | index | number |
| 0 | Object | Infinity | Infinity | | |
| 1 | | Infinity | 0.000 | | |
| 2* | First lens | −2.20574 | 0.400 | 1.537 | 55.7 |
| 3* | | 6.85 | 0.884 | | |
| 4* | Second lens | 1.92 | 0.800 | 1.619 | 25.9 |
| 5* | | 2.93 | 0.505 | | |
| | (STOP) | Infinity | −0.045 | | |
| 6* | Third lens | 4.834766 | 0.673 | 1.546 | 56.0 |
| 7* | | −5.97 | 0.094 | | |
| 8* | Fourth lens | 6.28 | 0.675 | 1.546 | 56.0 |
| 9* | | −1.86 | 0.050 | | |
| 10* | Fifth lens | −3.11 | 0.230 | 1.677 | 19.2 |
| 11* | | 10.01 | 0.409 | | |
| 12* | Sixth lens | −3.49 | 0.651 | 1.546 | 56.0 |
| 13* | | −1.48 | 0.050 | | |
| 14* | Seventh lens | 1.77 | 0.739 | 1.667 | 25.9 |
| 15* | | 1.21 | 0.490 | | |
| 16 | IR cut Filter | Infinity | 0.210 | 1.518 | 64.2 |
| 17 | | Infinity | 0.670 | | |
| 18 | Image | Infinity | 0.020 | | |

Table 6 is a table illustrating an aspherical value of the optical imaging system 300 according to the third embodiment of the present disclosure.

TABLE 6

| Surface No. | 2 | 3 | 4 | 5 | 6 | 7 | 8 |
|---|---|---|---|---|---|---|---|
| K | −20.649 | −59.969 | −2.996 | −2.091 | −3.499 | 19.998 | 17.640 |
| A | 0.107 | 0.360 | 0.028 | 0.083 | −0.010 | −0.187 | −0.202 |
| B | −0.087 | −0.573 | 0.298 | 0.046 | 0.432 | −0.012 | 0.348 |
| C | 0.053 | 1.242 | −2.213 | −2.353 | −6.373 | 1.705 | −2.336 |
| D | −0.025 | −2.537 | 9.731 | 33.900 | 59.876 | −11.511 | 12.626 |
| E | 0.009 | 3.983 | −28.511 | −256.929 | −382.805 | 49.835 | −45.034 |
| F | −0.002 | −4.581 | 58.417 | 1237.450 | 1731.513 | −152.119 | 109.063 |
| G | 0.000 | 3.850 | −85.805 | −4056.938 | −5662.299 | 340.133 | −181.307 |
| H | 0.000 | −2.369 | 91.392 | 9347.220 | 13504.759 | −570.807 | 203.590 |
| J | 0.000 | 1.063 | −70.623 | −15310.44 | −23444.91 | 726.594 | −144.603 |
| L | 0.000 | −0.344 | 39.153 | 17745.549 | 29234.491 | −696.127 | 50.453 |
| M | 0.000 | 0.078 | −15.161 | −14227.14 | −25447.89 | 486.540 | 8.007 |
| N | 0.000 | −0.012 | 3.889 | 7504.268 | 14650.860 | −232.999 | −16.304 |
| O | 0.000 | 0.001 | −0.594 | −2342.290 | −5004.564 | 67.853 | 6.516 |
| P | 0.000 | 0.000 | 0.041 | 327.696 | 766.904 | −8.998 | −0.934 |

| | 9 | 10 | 11 | 12 | 13 | 14 | 15 |
|---|---|---|---|---|---|---|---|
| K | −1.831 | 2.802 | −61.680 | −6.799 | −1.513 | −0.924 | −0.874 |
| A | 0.776 | 0.822 | 0.239 | 0.237 | 0.038 | −0.210 | −0.315 |
| B | −5.318 | −5.587 | −1.601 | −0.420 | 0.040 | 0.179 | 0.285 |
| C | 22.823 | 21.834 | 4.898 | 0.366 | 0.053 | −0.147 | −0.250 |
| D | −75.870 | −63.996 | −10.395 | 0.326 | −0.545 | 0.069 | 0.171 |
| E | 197.862 | 147.273 | 16.617 | −1.882 | 1.391 | 0.007 | −0.087 |
| F | −402.00 | −265.987 | −20.289 | 3.598 | −2.081 | −0.035 | 0.033 |
| G | 630.376 | 373.995 | 18.825 | −4.214 | 2.085 | 0.027 | −0.009 |
| H | −755.466 | −406.389 | −13.148 | 3.351 | −1.458 | −0.012 | 0.002 |
| J | −682.583 | 337.609 | 6.830 | −1.867 | 0.719 | 0.004 | 0.000 |
| L | −455.084 | −210.175 | −2.591 | 0.732 | −0.249 | −0.001 | 0.000 |
| M | 216.225 | 94.632 | 0.696 | −0.199 | 0.059 | 0.000 | 0.000 |
| N | −69.013 | −28.980 | −0.125 | 0.036 | −0.009 | 0.000 | 0.000 |
| O | 13.219 | 5.376 | 0.014 | −0.004 | 0.001 | 0.000 | 0.000 |
| P | −1.145 | −0.454 | −0.001 | 0.000 | 0.000 | 0.000 | 0.000 |

### Fourth Embodiment

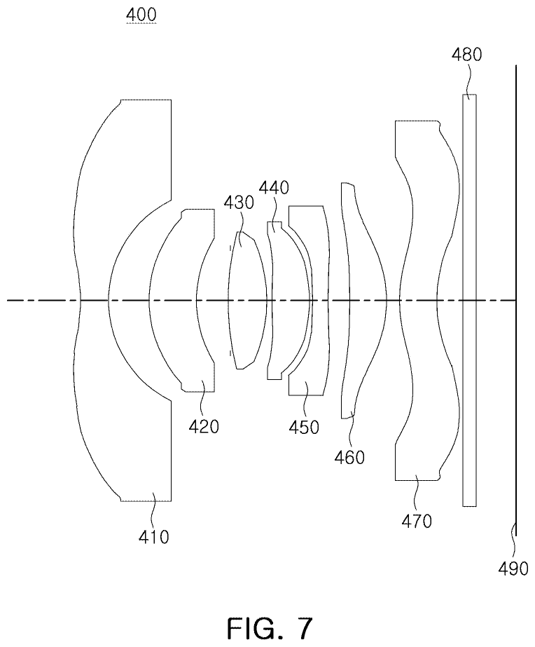

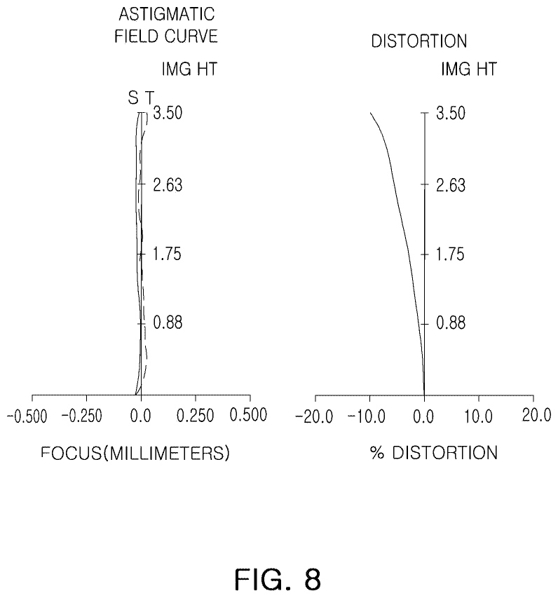

FIG. 7 is a configuration diagram of an optical imaging system according to a fourth embodiment of the present disclosure, and FIG. 8 is a graph illustrating the aberration characteristics of the optical imaging system illustrated in FIG. 7.

An optical imaging system 400, according to a fourth embodiment of the present disclosure, may include a first lens 410, a second lens 420, a third lens 430, a fourth lens 440, a fifth lens 450, a sixth lens 460, and a seventh lens 470.

The first lens 410 may have negative refractive power, and both an object-side surface and an image-side surface of the first lens 410 may be concave. In addition, the object-side surface of the first lens 410 may include at least one inflection point. That is, the object-side surface of the first lens 410 may be concave in a paraxial portion, but may be convex in an edge portion. The second lens 420 may have positive refractive power, an object-side surface of the second lens 420 may be convex, and an image-side surface of the second lens 420 may be concave. The third lens 430 may have positive refractive power, and both an object-side surface and an image-side surface of the third lens 430 may be convex. The fourth lens 440 may have positive refractive power, and both an object-side surface and an image-side surface of the fourth lens 440 may be convex. The fifth lens 450 may have negative refractive power, and both an object-side surface and an image-side surface of the fifth lens 450 may be concave. In addition, the image-side surface of the fifth lens 450 may include at least one inflection point. That is, the image-side surface of the fifth lens 450 may be concave in a paraxial portion, but may be convex in an edge portion. The sixth lens 460 may have positive refractive power, an object-side surface of the sixth lens 460 may be concave, and an image-side surface of the sixth lens 460 may be convex. The seventh lens 470 may have negative refractive power, an object-side surface of the seventh lens 470 may be convex, and an image-side surface of the seventh lens 470 may be concave. In addition, each of the object-side surface and the image-side surface of the seventh lens 470 may include at least one inflection point. That is, the object-side surface of the seventh lens 470 may be convex in a paraxial portion, but may be concave in an edge portion, and the image-side surface of the seventh lens 470 may be concave in the paraxial portion, but may be convex in the edge portion.

The optical imaging system 400, according to the fourth embodiment of the present disclosure, may include an infrared cut filter 480 and an image sensor 490 after the seventh lens 470, and may further include a STOP between the second lens 420 and the third lens 430.

Table 7 illustrates the characteristics of the optical imaging system 400 according to the fourth embodiment of the present disclosure. A focal length of the optical imaging system 400, according to the fourth embodiment of the present disclosure, is 2.0 mm, a field of view is 125.0 degrees, a height of an image plane is 7.0 mm, and a F value is 1.7.

TABLE 7

| Surface No. | | | | Refrac- | |
|---|---|---|---|---|---|
| (*aspherical | | Radius of | Thickness, | tive | Abbe |
| surface) | Component | curvature | distance | index | number |
| 0 | Object | Infinity | Infinity | | |
| 1 | | Infinity | 0.000 | | |
| 2* | First lens | −1.56746 | 0.477 | 1.537 | 55.7 |
| 3* | | −43.54 | 0.689 | | |
| 4* | Second lens | 2.08 | 0.834 | 1.619 | 25.9 |
| 5* | | 3.42 | 0.594 | | |
| | (STOP) | Infinity | −0.053 | | |
| 6* | Third lens | 4.892593 | 0.685 | 1.546 | 56.0 |
| 7* | | −5.40 | 0.075 | | |
| 8* | Fourth lens | 8.30 | 0.668 | 1.546 | 56.0 |
| 9* | | −2.04 | 0.050 | | |
| 10* | Fifth lens | −4.14 | 0.250 | 1.677 | 19.2 |
| 11* | | 8.96 | 0.385 | | |
| 12* | Sixth lens | −3.96 | 0.650 | 1.546 | 56.0 |
| 13* | | −1.34 | 0.217 | | |
| 14* | Seventh lens | 2.27 | 0.606 | 1.667 | 25.9 |
| 15* | | 1.32 | 0.488 | | |
| 16 | IR cut Filter | Infinity | 0.210 | 1.518 | 64.2 |
| 17 | | Infinity | 0.665 | | |
| 18 | Image | Infinity | 0.025 | | |

Table 8 is a table illustrating an aspherical value of the optical imaging system 400 according to the fourth embodiment of the present disclosure.

TABLE 8

| Surface No. | 2 | 3 | 4 | 5 | 6 | 7 | 8 |
|---|---|---|---|---|---|---|---|
| K | −10.873 | 2.001 | −2.893 | −4.071 | −1.753 | −74.160 | 30.735 |
| A | 0.139 | 0.449 | 0.056 | 0.091 | −0.002 | −0.206 | −0.161 |
| B | −0.113 | −0.676 | 0.083 | −0.199 | 0.248 | −0.086 | 0.299 |
| C | 0.071 | 1.542 | −0.908 | 0.969 | −2.604 | 2.962 | −1.952 |
| D | −0.034 | −3.490 | 4.007 | 1.262 | 16.621 | −21.257 | 10.804 |
| E | 0.012 | 6.094 | −11.075 | −37.924 | −64.463 | 96.847 | −41.760 |
| F | −0.003 | −7.760 | 20.993 | 219.828 | 136.422 | −304.523 | 114.393 |
| G | 0.001 | 7.197 | −28.314 | −728.429 | −38.446 | 681.720 | −225.736 |
| H | 0.000 | −4.879 | 27.609 | 1592.682 | −680.921 | −1104.889 | 322.449 |
| J | 0.000 | 2.413 | −19.509 | −2403.259 | 2249.321 | 1303.981 | −331.460 |
| L | 0.000 | −0.860 | 9.886 | 2525.241 | −3879.097 | −1113.579 | 240.961 |
| M | 0.000 | 0.215 | −3.498 | −1818.182 | 4151.964 | 672.657 | −119.778 |
| N | 0.000 | −0.036 | 0.820 | 856.202 | −2773.849 | −273.457 | 38.275 |
| O | 0.000 | 0.004 | −0.114 | −237.670 | 1064.661 | 67.295 | −6.962 |
| P | 0.000 | 0.000 | 0.007 | 29.493 | −179.859 | −7.587 | 0.532 |

| | 9 | 10 | 11 | 12 | 13 | 14 | 15 |
|---|---|---|---|---|---|---|---|
| K | −1.614 | 4.774 | −48.504 | 0.598 | −1.754 | −1.561 | −0.900 |
| A | 0.675 | 0.679 | 0.220 | 0.239 | 0.236 | 0.013 | −0.234 |
| B | −4.981 | −5.015 | −1.498 | −0.347 | −0.483 | −0.241 | 0.170 |
| C | 22.222 | 19.753 | 4.485 | 0.099 | 1.003 | 0.444 | −0.126 |
| D | −74.182 | −56.132 | −9.150 | 0.798 | −1.910 | −0.530 | 0.074 |
| E | 192.020 | 122.948 | 13.911 | −2.141 | 2.937 | 0.446 | −0.032 |
| F | −388.754 | −211.703 | −16.169 | 3.082 | −3.404 | −0.270 | 0.010 |
| G | 611.672 | 286.594 | 14.408 | −2.919 | 2.901 | 0.120 | −0.002 |
| H | −738.539 | −302.570 | −9.784 | 1.910 | −1.801 | −0.039 | 0.000 |
| J | 672.875 | 245.611 | 5.009 | −0.874 | 0.807 | 0.009 | 0.000 |
| L | −451.970 | −149.821 | −1.900 | 0.278 | −0.257 | −0.002 | 0.000 |
| M | 216.083 | 66.177 | 0.519 | −0.060 | 0.057 | 0.000 | 0.000 |
| N | −69.343 | −19.897 | −0.096 | 0.008 | −0.008 | 0.000 | 0.000 |
| O | 13.355 | 3.628 | 0.011 | −0.001 | 0.001 | 0.000 | 0.000 |
| P | −1.164 | −0.302 | −0.001 | 0.000 | 0.000 | 0.000 | 0.000 |

### Fifth Embodiment

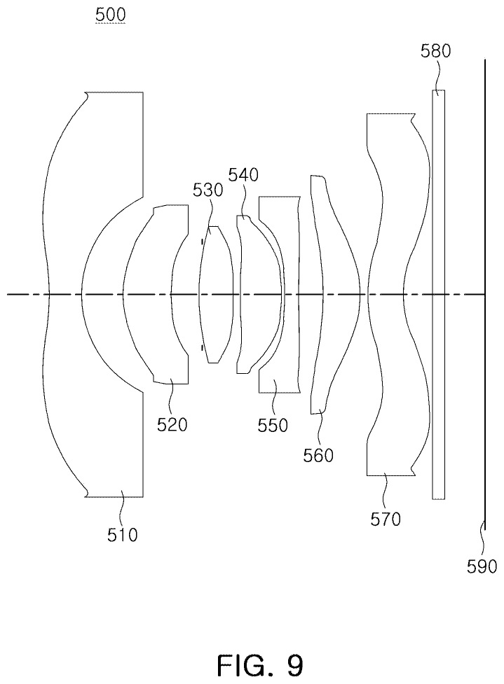

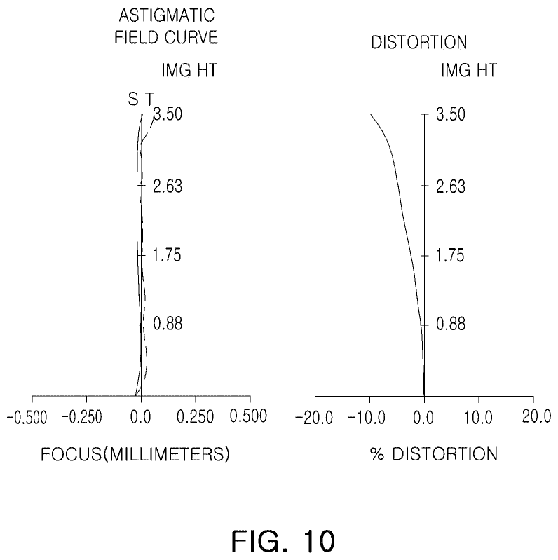

FIG. 9 is a configuration diagram of an optical imaging system according to a fifth embodiment of the present disclosure, and FIG. 10 is a graph illustrating the aberration characteristics of the optical imaging system illustrated in FIG. 9.

An optical imaging system 500, according to a fifth embodiment of the present disclosure, may include a first lens 510, a second lens 520, a third lens 530, a fourth lens 540, a fifth lens 550, a sixth lens 560, and a seventh lens 570.

The first lens 510 may have negative refractive power, and both an object-side surface and an image-side surface of the first lens 510 may be concave. In addition, the object-side surface of the first lens 510 may include at least one inflection point. That is, the object-side surface of the first lens 510 may be concave in a paraxial portion, but may be convex in an edge portion. The second lens 520 may have positive refractive power, an object-side surface of the second lens 520 may be convex, and an image-side surface of the second lens 520 may be concave. The third lens 530 may have positive refractive power, and both an object-side surface and an image-side surface of the third lens 530 may be convex. The fourth lens 540 may have positive refractive power, and both an object-side surface and an image-side surface of the fourth lens 540 may be convex. The fifth lens 550 may have negative refractive power, and both an object-side surface and an image-side surface of the fifth lens 550 may be concave. In addition, the image-side surface of the fifth lens 550 may include at least one inflection point. That is, the image-side surface of the fifth lens 550 may be concave in a paraxial portion, but may be convex in an edge portion. The sixth lens 560 may have positive refractive power, an object-side surface of the sixth lens 560 may be concave, and an image-side surface of the sixth lens 560 may be convex. The seventh lens 570 may have negative refractive power, an object-side surface of the seventh lens 570 may be convex, and an image-side surface of the seventh lens 570 may be concave. In addition, each of the object-side surface and the image-side surface of the seventh lens 570 may include at least one inflection point. That is, the object-side surface of the seventh lens 570 may be convex in a paraxial portion, but may be concave in an edge portion, and the image-side surface of the seventh lens 570 may be concave in the paraxial portion, but may be convex in the edge portion.

The optical imaging system 500, according to the fifth embodiment of the present disclosure, may include an infrared cut filter 580 and an image sensor 590 after the seventh lens 570, and may further include a STOP between the second lens 520 and the third lens 530.

Table 9 illustrates the characteristics of the optical imaging system 500 according to the fifth embodiment of the present disclosure. A focal length of the optical imaging system 500, according to the fifth embodiment of the present disclosure, is 2.0 mm, a field of view is 125.2 degrees, a height of an image plane is 7.0 mm, and a F value is 1.7.

TABLE 9

| Surface No. | | | | | |
|---|---|---|---|---|---|
| (*aspherical | | Radius of | Thickness, | Refractive | Abbe |
| surface) | Component | curvature | distance | index | number |
| 0 | Object | Infinity | Infinity | | |
| 1 | | Infinity | 0.000 | | |
| 2* | First lens | −1.86618 | 0.565 | 1.537 | 55.7 |
| 3* | | 12.27 | 0.704 | | |
| 4* | Second lens | 2.00 | 0.825 | 1.619 | 25.9 |
| 5* | | 3.15 | 0.548 | | |
| | (STOP) | Infinity | −0.070 | | |
| 6* | Third lens | 4.43013 | 0.599 | 1.546 | 56.0 |
| 7* | | −12.74 | 0.106 | | |
| 8* | Fourth lens | 4.74 | 0.733 | 1.546 | 56.0 |
| 9* | | −1.72 | 0.050 | | |
| 10* | Fifth lens | −3.33 | 0.250 | 1.677 | 19.2 |
| 11* | | 10.11 | 0.406 | | |
| 12* | Sixth lens | −3.43 | 0.650 | 1.546 | 56.0 |
| 13* | | −1.33 | 0.119 | | |
| 14* | Seventh lens | 2.09 | 0.621 | 1.667 | 25.9 |
| 15* | | 1.26 | 0.510 | | |
| 16 | IR cut Filter | Infinity | 0.210 | 1.518 | 64.2 |
| 17 | | Infinity | 0.665 | | |
| 18 | Image | Infinity | 0.025 | | |

Table 10 is a table illustrating an aspherical value of the optical imaging system 500 according to the fifth embodiment of the present disclosure.

TABLE 10

| Surface No. | 2 | 3 | 4 | 5 | 6 | 7 | 8 |
|---|---|---|---|---|---|---|---|
| K | −13.293 | −33.456 | −3.416 | −3.505 | 1.015 | −0.537 | 13.044 |
| A | 0.104 | 0.358 | 0.049 | 0.098 | −0.011 | −0.142 | −0.163 |
| B | −0.075 | −0.589 | 0.200 | −0.504 | 0.346 | −0.288 | 0.375 |
| C | 0.043 | 1.669 | −1.793 | 4.704 | −4.152 | 4.050 | −3.482 |
| D | −0.020 | −4.420 | 8.109 | −27.074 | 31.490 | −28.968 | 20.794 |
| E | 0.007 | 8.629 | −23.654 | 106.007 | −156.476 | 137.253 | −83.408 |
| F | −0.002 | −12.039 | 47.617 | −288.997 | 528.925 | −449.553 | 234.849 |
| G | 0.000 | 12.096 | −68.220 | 552.734 | −1238.162 | 1045.083 | −475.016 |
| H | 0.000 | −8.820 | 70.562 | −728.998 | 2007.777 | −1748.818 | 697.897 |
| J | 0.000 | 4.665 | −52.795 | 623.369 | −2207.893 | 2112.132 | −745.309 |
| L | 0.000 | −1.769 | 28.283 | −278.388 | 1549.179 | −1823.610 | 572.173 |
| M | 0.000 | 0.469 | −10.567 | −24.339 | −577.295 | 1097.121 | −307.355 |
| N | 0.000 | −0.082 | 2.613 | 105.761 | 13.785 | −436.685 | 109.537 |
| O | 0.000 | 0.009 | −0.384 | −53.935 | 71.293 | 103.322 | −23.239 |
| P | 0.000 | 0.000 | 0.025 | 9.667 | −18.801 | −11.001 | 2.219 |

| | 9 | 10 | 11 | 12 | 13 | 14 | 15 |
|---|---|---|---|---|---|---|---|
| K | −2.157 | 3.201 | −42.287 | 0.230 | −1.636 | −1.677 | −0.917 |
| A | 0.831 | 0.853 | 0.223 | 0.203 | 0.193 | −0.029 | −0.273 |
| B | −5.597 | −5.570 | −1.418 | −0.252 | −0.383 | −0.206 | 0.208 |
| C | 23.832 | 20.926 | 4.059 | −0.099 | 0.741 | 0.456 | −0.143 |
| D | −78.640 | −58.306 | −8.291 | 1.348 | −1.204 | −0.569 | 0.075 |
| E | 201.801 | 122.173 | 12.875 | −3.490 | 1.663 | 0.477 | −0.029 |
| F | −399.220 | −188.886 | −15.200 | 5.339 | −1.878 | −0.283 | 0.008 |
| G | 604.728 | 210.758 | 13.552 | −5.491 | 1.633 | 0.121 | −0.002 |
| H | −696.320 | −163.896 | −9.072 | 3.959 | −1.051 | −0.038 | 0.000 |
| J | 602.504 | 81.852 | 4.524 | −2.027 | 0.489 | 0.009 | 0.000 |
| L | −384.255 | −19.396 | −1.655 | 0.733 | −0.162 | −0.001 | 0.000 |
| M | 174.849 | −3.709 | 0.430 | −0.183 | 0.037 | 0.000 | 0.000 |
| N | −53.627 | 4.297 | −0.075 | 0.030 | −0.005 | 0.000 | 0.000 |
| O | 9.923 | −1.263 | 0.008 | −0.003 | 0.000 | 0.000 | 0.000 |
| P | −0.836 | 0.137 | 0.000 | 0.000 | 0.000 | 0.000 | 0.000 |

### Sixth Embodiment

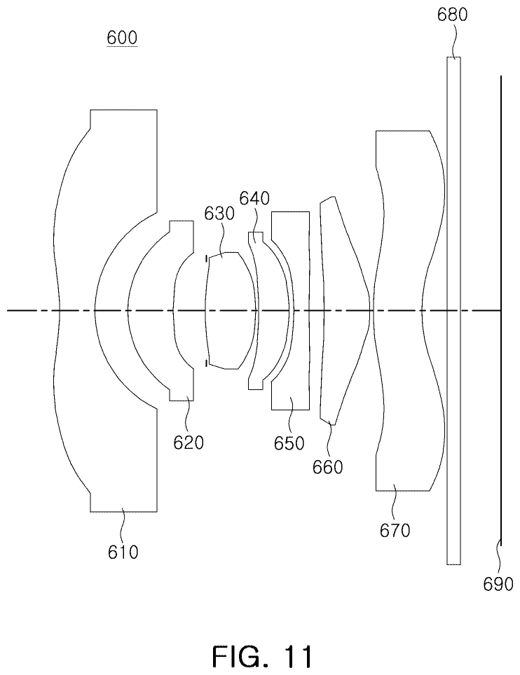

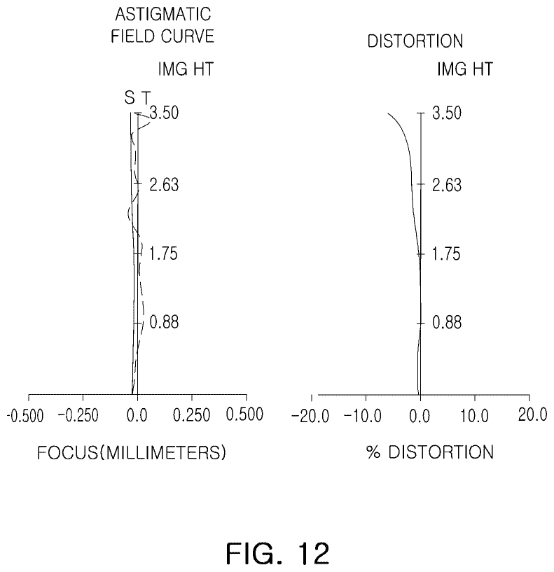

FIG. 11 is a configuration diagram of an optical imaging system according to a sixth embodiment of the present disclosure, and FIG. 12 is a graph illustrating the aberration characteristics of the optical imaging system illustrated in FIG. 11.

An optical imaging system 600, according to a sixth embodiment of the present disclosure, may include a first lens 610, a second lens 620, a third lens 630, a fourth lens 640, a fifth lens 650, a sixth lens 660, and a seventh lens 670.

The first lens 610 may have negative refractive power, and both an object-side surface and an image-side surface of the first lens 610 may be concave. In addition, the object-side surface of the first lens 610 may include at least one inflection point. That is, the object-side surface of the first lens 610 may be concave in a paraxial portion, but may be convex in an edge portion. The second lens 620 may have positive refractive power, an object-side surface of the second lens 620 may be convex, and an image-side surface of the second lens 620 may be concave. The third lens 630 may have positive refractive power, and both an object-side surface and an image-side surface of the third lens 630 may be convex. The fourth lens 640 may have positive refractive power, and an object-side surface of the fourth lens 640 may be concave, and an image-side surface of the fourth lens 640 may be convex. The fifth lens 650 may have negative refractive power, and both an object-side surface and an image-side surface of the fifth lens 650 may be concave. In addition, the image-side surface of the fifth lens 550 may include at least one inflection point. That is, the image-side surface of the fifth lens 650 may be concave in a paraxial portion, but may be convex in an edge portion. The sixth lens 660 may have positive refractive power, an object-side surface of the sixth lens 660 may be concave, and an image-side surface of the sixth lens 660 may be convex. The seventh lens 670 may have negative refractive power, an object-side surface of the seventh lens 670 may be convex, and an image-side surface of the seventh lens 670 may be concave. In addition, each of the object-side surface and the image-side surface of the seventh lens 670 may include at least one inflection point. That is, the object-side surface of the seventh lens 670 may be convex in a paraxial portion, but may be concave in an edge portion, and the image-side surface of the seventh lens 670 may be concave in the paraxial portion, but may be convex in the edge portion.

The optical imaging system 600, according to the sixth embodiment of the present disclosure, may include an infrared cut filter 680 and an image sensor 690 after the seventh lens 670, and may further include a STOP between the second lens 620 and the third lens 630.

Table 11 illustrates the characteristics of the optical imaging system 600 according to the sixth embodiment of the present disclosure. A focal length of the optical imaging system 600, according to the sixth embodiment of the present disclosure, is 1.9 mm, a field of view is 124.5 degrees, a height of an image plane is 7.0 mm, and a F value is 1.7.

TABLE 11

| Surface No. | | | | Refrac- | |
|---|---|---|---|---|---|
| (*aspherical | | Radius of | Thickness, | tive | Abbe |
| surface) | Component | curvature | distance | index | number |
| 0 | Object | Infinity | Infinity | | |
| 1 | | Infinity | 0.000 | | |
| 2* | First lens | −1.77478 | 0.603 | 1.537 | 55.7 |
| 3* | | 18.08 | 0.580 | | |
| 4* | Second lens | 1.89 | 0.758 | 1.619 | 25.9 |
| 5* | | 2.71 | 0.626 | | |
| | (STOP) | Infinity | −0.056 | | |
| 6* | Third lens | 4.175721 | 0.869 | 1.546 | 56.0 |
| 7* | | −3.31 | 0.057 | | |
| 8* | Fourth lens | −198.39 | 0.534 | 1.546 | 56.0 |
| 9* | | −1.86 | 0.076 | | |
| 10* | Fifth lens | −3.76 | 0.247 | 1.677 | 19.2 |
| 11* | | 6.91 | 0.269 | | |
| 12* | Sixth lens | −4.75 | 0.793 | 1.546 | 56.0 |
| 13* | | −1.38 | 0.050 | | |
| 14* | Seventh lens | 2.75 | 0.839 | 1.667 | 25.9 |
| 15* | | 1.52 | 0.440 | | |
| 16 | IR cut Filter | Infinity | 0.210 | 1.518 | 64.2 |
| 17 | | Infinity | 0.682 | | |
| 18 | Image | Infinity | 0.020 | | |

Table 12 illustrates an aspherical value of the optical imaging system 600 according to the sixth embodiment of the present disclosure.

TABLE 12

| Surface No. | 2 | 3 | 4 | 5 | 6 | 7 | 8 |
|---|---|---|---|---|---|---|---|
| K | −12.163 | 77.027 | −3.470 | 0.444 | −15.013 | 6.538 | 99.000 |
| A | 0.120 | 0.370 | 0.053 | 0.038 | 0.040 | −0.027 | 0.006 |
| B | −0.092 | −0.373 | 0.711 | 1.292 | −0.733 | −1.453 | −1.670 |
| C | 0.055 | 0.562 | −5.397 | −17.440 | 13.500 | 12.776 | 13.651 |
| D | −0.024 | −1.414 | 23.402 | 143.103 | −144.877 | −80.576 | −78.842 |
| E | 0.008 | 3.370 | −66.889 | −772.565 | 999.598 | 375.269 | 321.729 |
| F | −0.002 | −5.782 | 133.153 | 2897.069 | −4708.978 | −1269.532 | −929.803 |
| G | 0.000 | 6.953 | −189.745 | −7765.419 | 15620.028 | 3110.265 | 1924.857 |
| H | 0.000 | −5.923 | 196.061 | 15093.184 | −37012.89 | −5521.054 | −2876.892 |
| J | 0.000 | 3.593 | −147.071 | −21325.23 | 62755.311 | 17075.381 | 3102.838 |
| L | 0.000 | −1.542 | 79.224 | 21686.927 | −75284.48 | −6465.643 | −2387.487 |
| M | 0.000 | 0.457 | −29.838 | −15464.43 | 62152.558 | 4102.205 | 1275.942 |
| N | 0.000 | −0.089 | 7.453 | 7336.022 | −33432.86 | −1715.360 | −449.346 |
| O | 0.000 | 0.010 | −1.109 | −2078.340 | 10488.731 | 424.850 | 93.651 |
| P | 0.000 | −0.001 | 0.074 | 265.932 | −1444.925 | −47.196 | −8.742 |

| | 9 | 10 | 11 | 12 | 13 | 14 | 15 |
|---|---|---|---|---|---|---|---|
| K | −6.532 | 6.699 | −60.946 | 2.605 | −1.755 | 0.007 | −0.802 |
| A | 0.474 | 0.469 | 0.108 | 0.185 | 0.064 | −0.071 | −0.232 |
| B | −2.743 | −2.677 | −0.691 | −0.129 | 0.163 | 0.015 | 0.200 |
| C | 7.889 | 6.610 | 0.518 | −0.276 | −0.605 | 0.001 | −0.165 |
| D | −15.580 | −10.084 | 3.326 | 0.933 | 1.193 | −0.017 | 0.103 |
| E | 23.527 | 14.337 | −12.921 | −1.448 | −1.583 | 0.026 | −0.047 |
| F | −34.889 | −34.029 | 25.025 | 1.498 | 1.484 | −0.021 | 0.016 |
| G | 62.005 | 86.673 | −31.652 | −1.132 | −1.006 | 0.011 | −0.004 |
| H | −107.145 | −156.474 | 27.975 | 0.642 | 0.498 | −0.004 | 0.001 |
| J | 141.128 | 189.450 | −17.618 | −0.274 | −0.180 | 0.001 | 0.000 |
| L | −129.663 | −154.201 | 7.880 | 0.086 | 0.047 | 0.000 | 0.000 |
| M | 80.188 | 83.457 | −2.447 | −0.019 | −0.009 | 0.000 | 0.000 |
| N | −31.872 | −28.819 | 0.502 | 0.003 | 0.001 | 0.000 | 0.000 |
| O | 7.367 | 5.745 | −0.061 | 0.000 | 0.000 | 0.000 | 0.000 |
| P | −0.754 | −0.503 | 0.003 | 0.000 | 0.000 | 0.000 | 0.000 |

### Seventh Embodiment

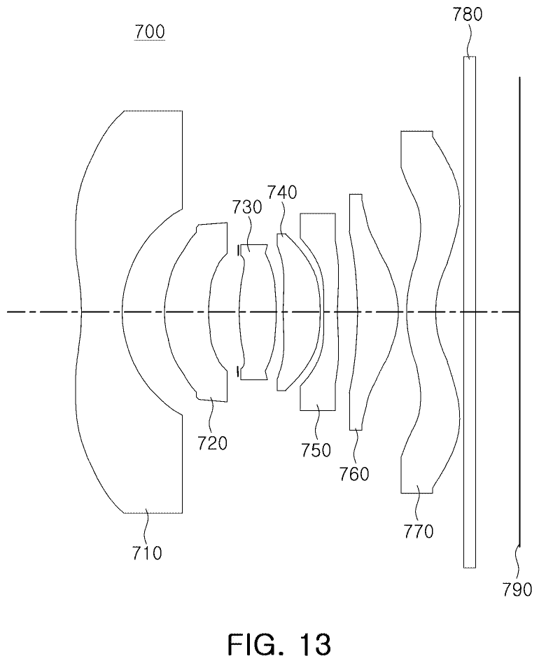

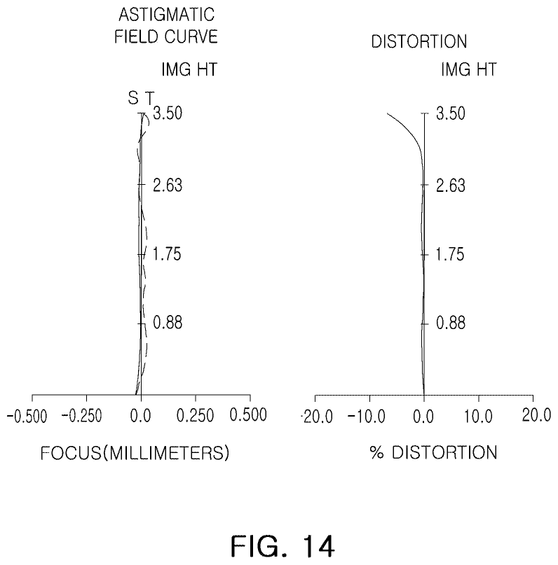

FIG. 13 is a configuration diagram of an optical imaging system according to a seventh embodiment of the present disclosure, and FIG. 14 is a graph illustrating the aberration characteristics of the optical imaging system illustrated in FIG. 13.

An optical imaging system 700, according to a seventh embodiment of the present disclosure, may include a first lens 710, a second lens 720, a third lens 730, a fourth lens 740, a fifth lens 750, a sixth lens 760, and a seventh lens 770.

The first lens 710 may have negative refractive power, and both an object-side surface and an image-side surface of the first lens 710 may be concave. In addition, the object-side surface of the first lens 710 may include at least one inflection point. That is, the object-side surface of the first lens 710 may be concave in a paraxial region, but may be convex in an edge portion. The second lens 720 may have positive refractive power, an object-side surface of the second lens 720 may be convex, and an image-side surface of the second lens 720 may be concave. The third lens 730 may have positive refractive power, and both an object-side surface and an image-side surface of the third lens 730 may be convex. The fourth lens 740 may have positive refractive power, and both an object-side surface and an image-side surface of the fourth lens 740 may be convex. The fifth lens 750 may have negative refractive power, and both an object-side surface and an image-side surface of the fifth lens 750 may be concave. In addition, the image-side surface of the fifth lens 750 may include at least one inflection point. That is, the image-side surface of the fifth lens 750 may be concave in a paraxial region, but may be convex in an edge portion. The sixth lens 760 may have positive refractive power, an object-side surface of the sixth lens 760 may be concave, and an image-side surface of the sixth lens 760 may be convex. The seventh lens 770 may have negative refractive power, an object-side surface of the seventh lens 770 may be convex, and an image-side surface of the seventh lens 770 may be concave. In addition, each of the object-side surface and the image-side surface of the seventh lens 770 may include at least one inflection point. That is, the object-side surface of the seventh lens 770 may be convex in a paraxial portion, but mat be concave in an edge portion, and the image-side surface of the seventh lens 770 may be concave in the paraxial portion, but may be convex in the edge portion.

The optical imaging system 700, according to the seventh embodiment of the present disclosure, may include an infrared cut filter 780 and an image sensor 790 after the seventh lens 770, and may further include a stop between the second lens 720 and the third lens 730.

Table 13 illustrates the characteristics of the optical imaging system 700 according to the seventh embodiment of the present disclosure. A focal length of the optical imaging system 700, according to the seventh embodiment of the present disclosure, is 2.0 mm, a field of view is 124.1 degrees, a height of an image plane is 7.0 mm, and a F value is 1.7.

TABLE 13

| Surface No. | | | | | |
|---|---|---|---|---|---|
| (*aspherical | | Radius of | Thickness, | Refractive | Abbe |
| surface) | Component | curvature | distance | index | number |
| 0 | Object | Infinity | Infinity | | |
| 1 | | Infinity | 0.871 | | |
| 2* | First lens | −1.8371 | 0.692 | 1.537 | 55.7 |
| 3* | | 97.24 | 0.740 | | |
| 4* | Second lens | 1.97 | 0.752 | 1.619 | 25.9 |
| 5* | | 2.56 | 0.625 | | |
| | (STOP) | Infinity | −0.070 | | |
| 6* | Third lens | 4.193659 | 0.635 | 1.546 | 56.0 |
| 7* | | −7.28 | 0.104 | | |
| 8* | Fourth lens | 6.55 | 0.653 | 1.546 | 56.0 |
| 9* | | −1.77 | 0.051 | | |
| 10* | Fifth lens | −3.53 | 0.240 | 1.677 | 19.2 |
| 11* | | 8.84 | 0.358 | | |
| 12* | Sixth lens | −3.94 | 0.692 | 1.546 | 56.0 |
| 13* | | −1.28 | 0.151 | | |
| 14* | Seventh lens | 1.77 | 0.477 | 1.667 | 25.9 |
| 15* | | 1.07 | 0.500 | | |
| 16 | IR cut Filter | Infinity | 0.210 | 1.518 | 64.2 |
| 17 | | Infinity | 0.744 | | |
| 18 | Image | Infinity | 0.025 | | |

Table 14 illustrates an aspherical value of the optical imaging system 700 according to the seventh embodiment of the present disclosure.

TABLE 14

| Surface No. | 2 | 3 | 4 | 5 | 6 | 7 | 8 |
|---|---|---|---|---|---|---|---|
| K | −11.028 | 99.000 | −2.265 | −4.894 | −10.132 | 37.671 | 24.197 |
| A | 0.097 | 0.323 | 0.047 | 0.163 | 0.043 | −0.211 | −0.173 |
| B | −0.064 | −0.463 | 0.241 | −1.054 | −0.682 | 1.121 | 0.180 |
| C | 0.034 | 1.316 | −2.029 | 10.368 | 8.089 | −13.762 | −1.359 |
| D | −0.014 | −3.623 | 8.845 | −67.786 | −55.584 | 109.229 | 7.818 |
| E | 0.005 | 7.264 | −25.170 | 309.215 | 223.185 | −573.824 | −35.731 |
| F | −0.001 | −10.296 | 49.958 | −1009.611 | −451.378 | 2089.928 | 127.982 |
| G | 0.000 | 10.434 | −71.257 | 2398.739 | −144.726 | −5415.270 | −338.109 |
| H | 0.000 | −7.632 | 73.999 | −4171.298 | 3672.691 | 10110.390 | 639.919 |
| J | 0.000 | 4.032 | −55.989 | 5287.484 | −11274.19 | −13625.71 | −858.452 |
| L | 0.000 | −1.522 | 30.509 | −4811.817 | 19227.650 | 13123.197 | 806.863 |
| M | 0.000 | 0.400 | −11.649 | 3049.015 | −20578.18 | −8801.523 | −518.530 |
| N | 0.000 | −0.069 | 2.955 | −127.226 | 13765.232 | 3901.935 | 216.706 |
| O | 0.000 | 0.007 | −0.447 | 311.790 | −5282.171 | −1027.088 | −53.003 |
| P | 0.000 | 0.000 | 0.030 | −33.855 | 890.014 | 121.479 | 5.751 |

| | 9 | 10 | 11 | 12 | 13 | 14 | 15 |
|---|---|---|---|---|---|---|---|
| K | −2.306 | 3.631 | −60.155 | 2.525 | −1.939 | −3.448 | −0.915 |
| A | 0.923 | 0.996 | 0.276 | 0.220 | 0.133 | −0.098 | −0.424 |
| B | −5.984 | −6.914 | −1.923 | −0.477 | −0.230 | −0.058 | 0.438 |
| C | 21.923 | 27.426 | 5.987 | 0.817 | 0.425 | 0.330 | −0.400 |
| D | −52.631 | −79.716 | −12.941 | −1.047 | −0.586 | −0.561 | 0.275 |
| E | 74.675 | 176.676 | 20.624 | 0.776 | 0.585 | 0.567 | −0.139 |
| F | −26.513 | −301.468 | −24.388 | −0.006 | −0.447 | −0.383 | 0.052 |
| G | −130.330 | 398.404 | 21.341 | −0.675 | 0.275 | 0.181 | −0.014 |
| H | 321.800 | −409.007 | −13.757 | 0.800 | −0.140 | −0.061 | 0.003 |
| J | −402.416 | 324.373 | 6.485 | −.516 | 0.056 | 0.015 | 0.000 |
| L | 319.750 | −194.969 | −2.205 | 0.212 | −0.017 | −0.003 | 0.000 |
| M | −167.268 | 85.601 | 0.526 | −0.057 | 0.004 | 0.000 | 0.000 |
| N | 56.006 | −25.770 | −0.084 | 0.010 | −0.001 | 0.000 | 0.000 |
| O | −10.902 | 4.732 | 0.008 | −0.001 | 0.000 | 0.000 | 0.000 |
| P | 0.939 | −0.398 | 0.000 | 0.000 | 0.000 | 0.000 | 0.000 |

### Eighth Embodiment

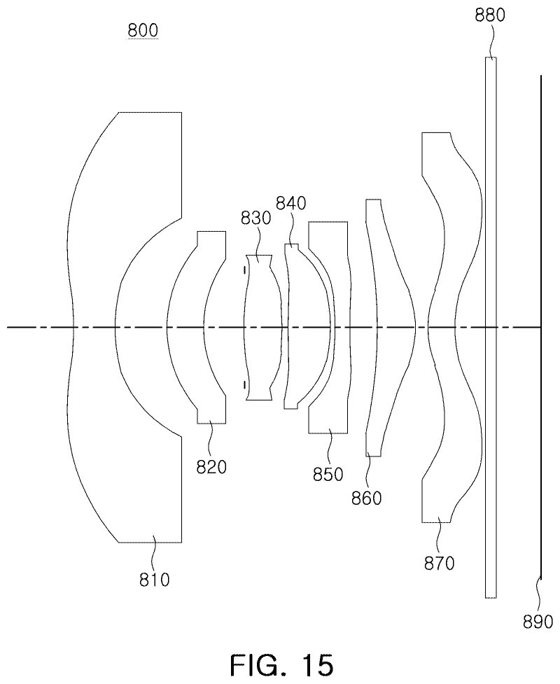

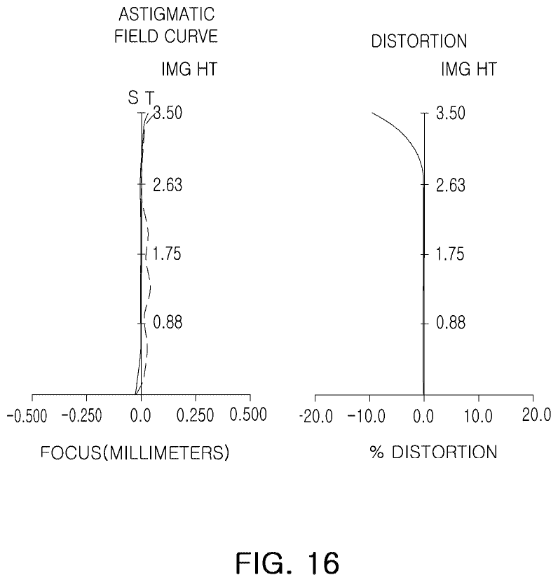

FIG. 15 is an optical imaging system configuration diagram according to an eighth embodiment of the present disclosure. FIG. 16 is a graph illustrating the aberration characteristics of the optical imaging system illustrated in FIG. 15.

An optical imaging system 800, according to an eighth embodiment of the present disclosure, may include a first lens 810, a second lens 820, a third lens 830, a fourth lens 840, a fifth lens 850, a sixth lens 860, and a seventh lens 870.

The first lens 810 may have negative refractive power, and both an object-side surface and an image-side surface of the first lens 810 may be concave. In addition, the object-side surface of the first lens 810 may include at least one inflection point. That is, the object-side surface of the first lens 810 may be concave in a paraxial portion, but may be convex in an edge portion. The second lens 820 may have positive refractive power, an object-side surface of the second lens 820 may be convex, and an image-side surface of the second lens 820 may be concave. The third lens 830 may have positive refractive power, and both an object-side surface and an image-side surface of the third lens 830 may be convex. The fourth lens 840 may have positive refractive power, and both an object-side surface and an image-side surface of the fourth lens 840 may be convex. The fifth lens 850 may have negative refractive power, and both an object-side surface and an image-side surface of the fifth lens 850 may be concave. In addition, the image-side surface of the fifth lens 850 may include at least one inflection point. That is, the image-side surface of the fifth lens 850 may be concave in a paraxial portion, but may be convex in an edge portion. The sixth lens 860 may have positive refractive power, an object-side surface of the sixth lens 860 may be concave, and an image-side surface of the sixth lens 860 may be convex. The seventh lens 870 may have negative refractive power, an object-side surface of the seventh lens 870 may be convex, and an image-side surface of the seventh lens 870 may be concave. In addition, each of the object-side surface and the image-side surface of the seventh lens 870 may include at least one inflection point. That is, the object-side surface of the seventh lens 870 may be convex in a paraxial portion, but may be concave in an edge portion, and the image-side surface of the seventh lens 870 may be concave in the paraxial portion, but may be convex in the edge portion.

The optical imaging system 800, according to the eighth embodiment of the present disclosure, may include an infrared cut filter 880 and an image sensor 890 after the seventh lens 870, and may further include a STOP between the second lens 820 and the third lens 830.

Table 15 illustrates the characteristics of the optical imaging system 800 according to the eighth embodiment of the present disclosure. A focal length of the optical imaging system 800, according to the eighth embodiment of the present disclosure, is 2.0 mm, a field of view is 124.3 degrees, a height of an image plane is 7.0 mm, and a F value is 1.7.

TABLE 15

| Surface No. | | | | | |
|---|---|---|---|---|---|
| (*aspherical | | Radius of | Thickness, | Refractive | Abbe |
| surface) | Component | curvature | distance | index | number |
| 0 | Object | Infinity | Infinity | | |
| 1 | | Infinity | 0.871 | | |
| 2* | First lens | −1.88752 | 0.673 | 1.537 | 55.7 |
| 3* | | 61.15 | 0.825 | | |
| 4* | Second lens | 2.08 | 0.610 | 1.619 | 25.9 |
| 5* | | 2.75 | 0.697 | | |
| | (STOP) | Infinity | −0.050 | | |
| 6* | Third lens | 4.208739 | 0.615 | 1.546 | 56.0 |
| 7* | | −7.59 | 0.106 | | |
| 8* | Fourth lens | 6.09 | 0.694 | 1.546 | 56.0 |
| 9* | | −1.78 | 0.054 | | |
| 10* | Fifth lens | −3.71 | 0.240 | 1.677 | 19.2 |
| 11* | | 7.71 | 0.452 | | |
| 12* | Sixth lens | −3.94 | 0.620 | 1.546 | 56.0 |
| 13* | | −1.26 | 0.206 | | |
| 14* | Seventh lens | 1.63 | 0.405 | 1.667 | 25.9 |
| 15* | | 0.98 | 0.512 | | |
| 16 | IR cut Filter | Infinity | 0.210 | 1.518 | 64.2 |
| 17 | | Infinity | 0.692 | | |
| 18 | Image | Infinity | 0.025 | | |

Table 16 illustrates an aspherical value of the optical imaging system 800 according to the eighth embodiment of the present disclosure.

TABLE 16

| Surface No. | 2 | 3 | 4 | 5 | 6 | 7 | 8 |
|---|---|---|---|---|---|---|---|
| K | −11.127 | 98.600 | −2.234 | −11.773 | −35.646 | 24.226 | 20.965 |
| A | 0.098 | 0.284 | 0.031 | 0.132 | 0.082 | −0.199 | −0.162 |
| B | −0.063 | −0.223 | 0.383 | −0.096 | −0.624 | 0.534 | −0.254 |
| C | 0.033 | 0.352 | −2.915 | 2.075 | 4.498 | −8.039 | 3.387 |
| D | −0.014 | −1.029 | 12.814 | −25.331 | −15.176 | 72.762 | −24.893 |
| E | 0.004 | 2.523 | −37.469 | 169.193 | −18.265 | −411.220 | 116.813 |
| F | −0.001 | −4.224 | 76.739 | −709.215 | 391.962 | 1568.127 | −364.458 |
| G | 0.000 | 4.869 | −113.042 | 2005.731 | −1776.671 | −4195.228 | 784.705 |
| H | 0.000 | −3.945 | 121.319 | −3962.842 | 4582.985 | 8025.506 | −1190.835 |
| J | 0.000 | 2.267 | −94.993 | 5542.473 | −7671.632 | −11034.19 | 1282.027 |
| L | 0.000 | −0.919 | 53.683 | −5466.908 | 8620.221 | 10812.803 | −971.871 |
| M | 0.000 | 0.257 | −21.316 | 3719.627 | −6460.909 | −7365.153 | 506.325 |
| N | 0.000 | −0.047 | 5.639 | −1661.097 | 3096.255 | 3311.441 | −172.278 |
| O | 0.000 | 0.005 | −0.892 | 438.079 | −856.426 | −882.942 | 34.421 |
| P | 0.000 | 0.000 | 0.064 | −51.695 | 103.685 | 105.664 | −3.059 |

| | 9 | 10 | 11 | 12 | 13 | 14 | 15 |
|---|---|---|---|---|---|---|---|
| K | −4.806 | 6.469 | −81.351 | 3.277 | −2.317 | −3.585 | −0.951 |
| A | 0.790 | 0.831 | 0.220 | 0.191 | 0.144 | −0.080 | −0.458 |
| B | −5.291 | −5.235 | −1.550 | −0.288 | −0.221 | −0.096 | 0.468 |
| C | 18.260 | 15.722 | 4.366 | 0.224 | 0.258 | 0.364 | −0.419 |
| D | −37.813 | −23.785 | −7.872 | 0.374 | −0.041 | −0.548 | 0.288 |
| E | 30.270 | −11.699 | 9.057 | −1.611 | −0.346 | 0.510 | −0.149 |
| F | 72.912 | 155.989 | −4.801 | 2.786 | 0.561 | −0.323 | 0.058 |
| G | −295.919 | −412.658 | −3.464 | −2.973 | −0.464 | 0.145 | −0.017 |
| H | 524.922 | 645.770 | 9.699 | 2.144 | 0.241 | −0.047 | 0.004 |
| J | −583.828 | −678.670 | −9.931 | −1.080 | −0.082 | 0.011 | −0.001 |
| L | 435.733 | 493.298 | 6.153 | 0.381 | 0.019 | −0.002 | 0.000 |
| M | −218.807 | −245.629 | −2.474 | −0.093 | −0.003 | 0.000 | 0.000 |
| N | 71.081 | 80.123 | 0.634 | 0.015 | 0.000 | 0.000 | 0.000 |
| O | −13.504 | −15.430 | −0.095 | −0.001 | 0.000 | 0.000 | 0.000 |
| P | 1.139 | 1.329 | 0.006 | 0.000 | 0.000 | 0.000 | 0.000 |

Table 17 is a table illustrating values related to Conditional Expressions 9 to 11 according to embodiments of the present disclosure.

TABLE 17

| Component | Ex1 | Ex2 | Ex3 | Ex4 | Ex5 | Ex6 | Ex7 | Ex8 |
|---|---|---|---|---|---|---|---|---|
| ET1 | 0.96 | 1.04 | 1.00 | 1.05 | 1.10 | 1.15 | 1.39 | 1.19 |
| SD1 | 3.25 | 3.25 | 3.26 | 3.25 | 3.25 | 3.15 | 3.24 | 3.22 |
| SD5 | 1.02 | 1.03 | 1.01 | 1.08 | 1.04 | 1.02 | 1.04 | 1.09 |
| SD6 | 1.10 | 1.09 | 1.09 | 1.10 | 1.09 | 1.09 | 1.07 | 1.07 |
| SD14 | 3.05 | 3.03 | 2.96 | 2.92 | 2.95 | 3.06 | 2.86 | 2.85 |
| ET1/CT1 | 2.41 | 2.59 | 2.49 | 2.62 | 1.95 | 1.91 | 2.00 | 1.77 |
| SD1/SD5 | 317 | 3.15 | 3.24 | 3.01 | 3.11 | 3.08 | 3.12 | 2.95 |
| SD6/SD14 | 0.36 | 0.36 | 0.37 | 0.38 | 0.37 | 0.36 | 0.37 | 0.38 |

An aspect of the present disclosure is to provide an optical imaging system that can obtain a bright image while satisfying requirements for high resolution.

As set forth above, an optical imaging system may provide clear and bright images according to the embodiments of the present disclosure.

While specific examples have been shown and described above, it will be apparent after an understanding of this disclosure that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner, and/or replaced or supplemented by other components or their equivalents. Therefore, the scope of the disclosure is defined not by the detailed description, but by the claims and their equivalents, and all variations within the scope of the claims and their equivalents are to be construed as being included in the disclosure.

What is claimed is:

1. An optical imaging system, comprising:
a first lens having a negative refractive power;
a second lens;
a third lens having a convex image-side surface;
a fourth lens;
a fifth lens having a negative refractive power;
a sixth lens having a positive refractive power; and
a seventh lens having a convex object-side surface,
wherein the first to seventh lenses are sequentially disposed from an object side, and TTL/IMH<1.2 is satisfied,
where TTL is a distance on an optical axis from an object-side surface of the first lens to an image plane, and IMH is a height of the image plane.

2. The optical imaging system of claim 1, wherein the second lens has a positive refractive power, and an image-side surface of the second surface is concave.

3. The optical imaging system of claim 1, wherein an object-side surface of the sixth lens is concave.

4. The optical imaging system of claim 1, wherein 50<FOV/f is satisfied,
where FOV is a field of view of the optical imaging system, and f is a focal length of the optical imaging system.

5. The optical imaging system of claim 1, wherein f/EPD<1.8 is satisfied,
where f is a focal length of the optical imaging system, and EPD is a diameter of an entrance pupil.

6. The optical imaging system of claim 1, wherein L6R1/CT6<−3 is satisfied,
where L6R1 is a radius of curvature of the object-side surface of the sixth lens, and CT6 is a central thickness of the sixth lens.

7. The optical imaging system of claim 1, wherein 15<v1−v2<40 and 0<v1−v5<45 are satisfied,
where v1 is an Abbe number of the first lens, v2 is an Abbe number of the second lens, and v5 is an Abbe number of the fifth lens.

8. The optical imaging system of claim 1, wherein 1.6<ET1/CT1 is satisfied,
where ET1 is an edge thickness of the first lens, and CT1 is a central thickness of the first lens.

9. The optical imaging system of claim 1, wherein an object-side surface of the first lens is concave, and the fourth lens has a positive refractive power.

10. The optical imaging system of claim 1, wherein an image-side surface of the fifth lens is concave, and the seventh lens has a negative refractive power.

11. An optical imaging system, comprising:
a first lens of which both an object-side surface and an image-side surface are concave;
a second lens;
a third lens having a positive refractive power;
a fourth lens having a positive refractive power;
a fifth lens;
a sixth lens having a concave object-side surface; and
a seventh lens having a convex object-side surface,
wherein the first to seventh lenses are sequentially disposed from an object side,
wherein any one or any combination of any two or more surfaces of the first lens and the seventh lens include one or more inflection points, and f/EPD<1.8 is satisfied,
where f is a focal length of the optical imaging system, and EPD is a diameter of an entrance pupil.

12. The optical imaging system of claim 11, wherein SD6/SD14<0.5 is satisfied,
where SD6 is an effective diameter of the image-side surface of the third lens, and SD14 is an effective diameter of the image-side surface of the seventh lens.

13. The optical imaging system of claim 11, wherein the first lens has a negative refractive power, and −4<f1/f<0 is satisfied,
where f1 is a focal distance of the first lens, and f is a focal length of the optical imaging system.

14. The optical imaging system of claim 11, wherein an image-side surface of the fifth lens is convex, and the seventh lens has a positive refractive power.

15. The optical imaging system of claim 11, wherein an image-side surface of the fifth lens is concave, and the seventh lens has a negative refractive power.

16. The optical imaging system of claim 11, wherein TTL/IMH<1.2 is satisfied,
where TTL is a distance on an optical axis from the object-side surface of the first lens to an image plane, and IMH is a height of the image plane.
